(19) United States
(12) Patent Application Publication
(10) Pub. No.: US 2016/0024760 A1
(43) Pub. Date: Jan. 28, 2016

(54) EMERGENCY WATER STORAGE SYSTEM

(71) Applicant: Jeremiah Cluff, Gilbert, AZ (US)

(72) Inventor: Jeremiah Cluff, Gilbert, AZ (US)

(21) Appl. No.: 14/810,276

(22) Filed: Jul. 27, 2015

Related U.S. Application Data
(60) Provisional application No. 62/029,345, filed on Jul. 25, 2014.

(51) Int. Cl. E03B 11/08; F16K 47/02

(52) U.S. Cl. CPC E03B 11/08; F16K 47/02

(57) ABSTRACT

An emergency water storage system comprises a water storage tank coupled in-line with a water heater, wherein water flows through the water storage tank into the water heater. The water storage system further comprises a vacuum avoidance valve coupled to water piping, wherein the vacuum avoidance valve is coupled after a by-pass valve. The water storage system also comprises a mid-tank feeder pipe, wherein water enters the water storage tank from a bottom of the mid tank pipe at a bottom of the water storage tank and leaves the water storage tank from a top of the mid tank pipe at the top of the tank. The emergency water storage system may also include a shut off/by-pass valve system. Further still the emergency water storage system comprises a mini-arrester to eliminate any hammering created by any air in the system.

### CROSS REFERENCE TO RELATED APPLICATION[S]

This application claims priority to U.S. Provisional Patent Application entitled “Emergency Water Storage System,” serial number 62/029,345, filed Jul. 25, 2015, the disclosures of which are hereby incorporated entirely herein by reference.

### BACKGROUND OF THE INVENTION

1. Technical Field

This invention relates generally to a water storage system and more particularly to an emergency water storage system fluidly coupled to a water heater.

2. State of the Art

Water is one of the most important natural resources people need. A person can only live 3 to 5 days without water in normal conditions. Since water is so important for survival it is necessary to store extra water for an emergency. Storing water can be difficult especially when a person needs a minimum of 1 gallon of water per day during an emergency. Storing water in small containers is possible but can be difficult to ensure water is safe for drinking especially if it has been stored for a long period of time. Storing water in a large container is possible but it can still be difficult to maintain fresh, drinkable water. Water stored in a stagnant container must be emptied and replenished at least twice a year to insure the waters' drinkability. Containers that are not filled with fresh water may become subject to bacteria, fungus or mildew and become undrinkable thus defeating the purpose of storing water in the first place. Generic information claims that water can be purified by adding bleach or other hash chemicals to stagnant water to make it drinkable, but there are many problems with this strategy. Adding too much chemical can make a person sick or not adding enough chemical to the water may make a person sick.

Due to the importance of fresh water it is important to store fresh water that re-circulates with fresh water from a city, municipal or a private water source. In times of an emergency it is important for a person to have a minimum 1 gallon of fresh water a day for survival. If the domestic or private water source is not available or contaminated it is necessary to have an existing emergency stock of water that is easily accessible for use.

Natural disasters can be a hurricane, tornado, flood, storm or any other act of God. Manmade disasters can be bombings, terrorist attacks, chemical attacks, damage to municipal water sources or the electrical power grid. These are just examples and not all-inclusive. Any of these or the combination of several can easily affect a person's ability to receive fresh water and survive.

Conventional emergency water storage systems are lacking in the ability to continuously provide fresh water. Accordingly, there is a need for an improved emergency water storage system.

### DISCLOSURE OF THE INVENTION

The present invention relates to an emergency water storage system that generally includes a water storage tank fluidly coupled in line with a water line entering a building, such as in line with a water heater, wherein the water entering the tank flows through the water storage tank and circulates through the water storage tank and enters the water heater. The circulation of the water through the water storage tank operates to enable fresh water to always be within the water storage tank.

According to embodiments of the present invention, an emergency water storage system comprises a water storage tank coupled in-line with a water heater, wherein water flows through the water storage tank into the water heater. The water storage system further comprises a vacuum avoidance valve coupled to water piping, wherein the vacuum avoidance valve is coupled after a by-pass valve. The water storage system also comprises a mid-tank feeder pipe, wherein water enters the water storage tank from a bottom of the mid tank pipe at a bottom of the water storage tank and leaves the water storage tank from a top of the mid tank pipe at the top of the tank. The emergency water storage system may also include a shut off/by-pass valve system. Further still the emergency water storage system comprises a mini-arrester to eliminate any hammering created by any air in the system.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of an emergency water storage system; and

FIG. 2 is another perspective view of an emergency water storage system.

FIG. 3 is another perspective view of an emergency water storage system.

### DETAILED DESCRIPTION OF EMBODIMENTS OF THE INVENTION

As discussed above, embodiments of the present invention relate to an emergency water storage system that generally includes a water storage tank fluidly coupled in line with a water line entering a building, such as in line with a water heater, wherein the water entering the tank flows through the water storage tank and circulates through the water storage tank and enters the water heater. The circulation of the water through the water storage tank operates to enable fresh water to always be within the water storage tank.

Because of various disaster scenarios an emergency water storage system according to embodiments of the present invention has been developed to store fresh water. Several conventional tanks have been designed to accomplish this feat in the past but there have been some problems with their design and this current design eliminates those problems.

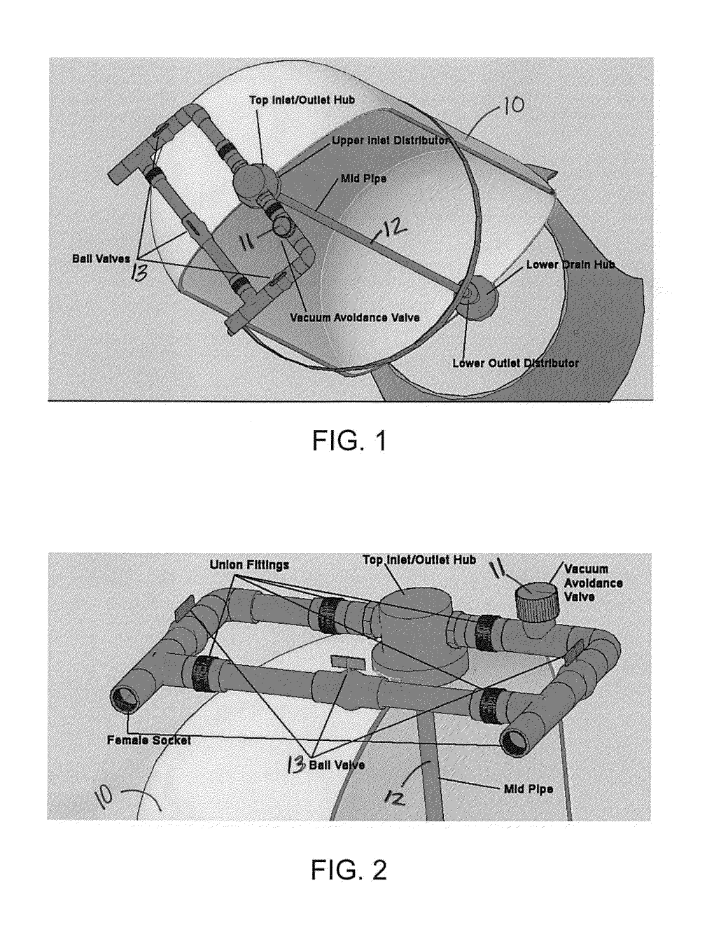

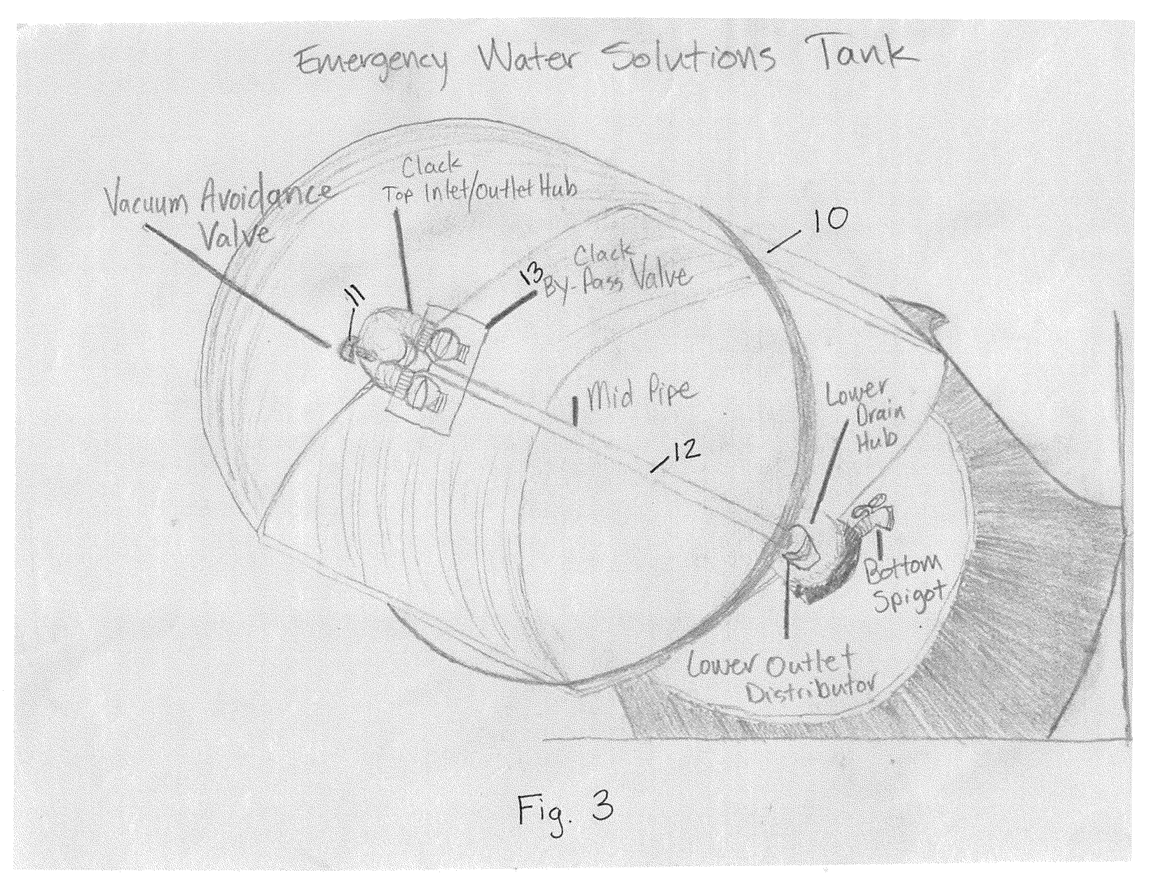

Referring to the drawings, FIGS. 1 and 2 depict an emergency water storage system comprises a water storage tank 10 coupled in-line with a water heater, wherein water flows through the water storage tank 10 into the water heater. The water storage system further comprises a vacuum avoidance valve 11 coupled to water piping, wherein the vacuum avoidance valve 11 is coupled after a by-pass valve. The water storage system also comprises a mid-tank feeder pipe 12, wherein water enters the water storage tank 10 from a bottom of the mid tank pipe at a bottom of the water storage tank 10 and leaves the water storage tank 10 from a top of the mid tank pipe at the top of the tank. The emergency water storage system may also include a shut off/by-pass valve system. Further still the emergency water storage system comprises a mini-arrester to eliminate any hammering created by any air in the system.

The basic layout of the water storage system consists of a large capacity storage tank 10 that is connected in-line with the water line from the city, municipality or private water source. The tank 10 is connected before water enters a water heater. Water from the street will enter the large capacity emergency water storage tank 10 and circulate through the tank 10 and then exit the tank 10 and enter the water heater where the water will proceed throughout the home or building as normal.

There are several differences that this tank design incorporates that make the function and design much better than conventional designs.

One aspect of embodiments of the present invention is the incorporation of a vacuum avoidance valve 11. This valve 11 is extremely important and must be used to ensure that the water within a tank 10 can properly be drained and used during an emergency. When a system is sealed and water is drained from the bottom of the tank 10 due to gravity the tank creates a vacuum. This causes two problems, first the water will drain slowly and second, and most importantly, the tank can implode on its self. If that happens, the tank 10 will crack and water will be lost defeating the purpose of storing water and the tank 10 will be unusable. The placement of the vacuum avoidance valve 11 is also very important and must be placed after the bypass valve system 13. In this location, when the valve/pipe is turned to a by-pass condition, and water is not entering the tank (at time of emergency), the vacuum avoidance valve 11 will still operate as intended because it is located past the shut off valve and part of the tank system space.

Another embodiment of the present invention includes a water storage tank 10 configuration that includes a mid-tank feeder pipe 12, wherein the water enters the tank 10 from the bottom of the pipe near the bottom of the tank 10 through a lower outlet distributor and a lower drain hub and leaves the tank from the top of the pipe 12, near the top of the tank 10 through a top inlet/outlet hub. Both of these locations also comprise a strainer, which helps filter the water if needed. This pipe layout helps in maintaining pressure throughout the system and most importantly allows the water to re circulate through the tank 10. If the pipes are not in the correct position in the tank the tank 10 will not maintain pressure and the water will not circulate which would be a major issue with bacteria, fungus etc. Previous designs have not incorporated this mid pipe 12 design and most do not consider the layout of the inlet and outlet of the water, which can greatly contribute to the loss of water pressure throughout the system and the lack of water circulation throughout the tank.

In yet another embodiment, this design may have a shut off/by-pass valve system 13(which may be where the vacuum avoidance valve 11 is installed). This is very important so the water can be turned off to the tank if the water becomes contaminated from the municipality, city or private water source. Also the by-pass function of the valve system 13 will allow water to by-pass the tank 10 if the tank 10 needs to be removed (if it becomes damaged, defective, etc). Without this valve system 13, the water to the whole house has to be turned off if anything has to be done with the tank. It will be understood that in some embodiments, the by-pass valve system 13 may be a Clack® by-pass valve system 13 as shown in FIG. 3. Additionally, the Clack ® by-pass valve 13 may be used with

In yet another embodiment, this tank design will have an access hole with a plug at the very bottom of the tank that can be removed if the tank needs to be cleaned of silt, etc. Without such access the cleaning of the tank 10 is greatly limited.

In other embodiments, this system will have a mini-arrester to eliminate any hammering created by any air in the system.

The design can be used in any residential or commercial building. Preferably it is connected on the hot water line before it enters a hot water heater but can also be installed on the cold sideline without the use of a water heater.

The tank 10 can be made of any safe drinking water material but the preferred design must be able to withstand a large amount of water pressure for prolonged periods without failing. A cylinder shape is the best shape to withstand a minimum 100 psi of water pressure.

Accordingly, the components of an emergency water storage system, with exception to materials of components already discussed having a particular material type, may be formed of any of many different types of materials or combinations thereof that can readily be formed into shaped objects provided that the components selected are consistent with the intended operation of an emergency water storage system. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof

Furthermore, the components defining any emergency water storage system may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner that allows the performance of the proper function of the component, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An emergency water storage system comprising:
a water storage tank coupled in-line with a water heater, wherein water flows through the water storage tank into the water heater;
a vacuum avoidance valve coupled to water piping, wherein the vacuum avoidance valve is coupled after a by-pass valve; and
a mid-tank feeder pipe, wherein water enters the water storage tank from a bottom of the mid tank pipe at a bottom of the water storage tank and leaves the water storage tank from a top of the mid tank pipe at the top of the tank;
a shut off/by-pass valve system; and
a mini-arrester to eliminate any hammering created by any air in the system.
